(19) United States
(12) Patent Application Publication
(10) Pub. No.: US 2025/0038459 A1
(43) Pub. Date: Jan. 30, 2025

(54) SHIELD TERMINAL

(71) Applicant: SUMITOMO WIRING SYSTEMS, LTD., Mie (JP)

(72) Inventor: Shuhei YAMADA, Mie (JP)

(21) Appl. No.: 18/772,666

(22) Filed: Jul. 15, 2024

(30) Foreign Application Priority Data
Jul. 28, 2023 (JP) 2023-122983

(51) Int. Cl. H01R 13/6593; H01R 13/506; H01R 13/6582

(52) U.S. Cl. CPC H01R 13/6593; H01R 13/506; H01R 13/6582

(57) ABSTRACT

A shield terminal includes a first outer conductor, a second outer conductor connected to the first outer conductor, and a module housed in the first outer conductor. The first outer conductor has one wall facing one side intersecting a front-rear direction, and an opening portion open to the one side at a position rearward of the one wall. The module has an inner conductor that is connected to a front end portion of a shielded electric wire and dielectrics and housing the inner conductor, and is disposed facing the opening portion. The second outer conductor has a cover wall covering the opening portion, and the cover wall has a second edge portion covering, from the one side, a first edge portion of the one wall facing the opening portion.

### CROSS-REFERENCE TO RELATED APPLICATIONS

This application is based on and claims priority from Japanese Patent Application No. 2023-122983, filed on Jul. 28, 2023, with the Japan Patent Office, the disclosure of which is incorporated herein in its entirety by reference.

### TECHNICAL FIELD

The present disclosure relates to a shield terminal.

### BACKGROUND

A shield terminal disclosed in JP 2018-147817 A includes inner conductors that are connected to core wires of a shielded electric wire, a dielectric housing the inner conductors, and a plurality of outer conductors surrounding the dielectric. The outer conductors are constituted by a first shell and a second shell that are connectable to each other. The first shell is a member that houses the dielectric. The second shell is attached to the first shell so as to cover an opening portion that is open in an upper wall of the first shell. The first shell and the second shell each have a barrel portion connected to a braided wire of the shielded electric wire. A front end portion of the second shell (see protruding portion of left end portion of reference numeral 39 in FIG. 13 of JP 2018-147817 A) bends obliquely downward and enters inside the upper wall of the first shell. A gap (slit) in a front-rear direction that can form between the upper wall of the first shell and the front end portion of the second shell is covered by the front end portion of the second shell (see FIG. 1 of JP 2018-147817 A). Shielding performance against noise is thereby ensured. This type of shield terminal is also disclosed in JP 2018-125199 A, JP 2018-006183 A, and JP 2017-004853 A.

### SUMMARY

Generally, a shield terminal has a large number of parts and tend to be complicated to assemble. Thus, a method for facilitating parts assembly using an automatic machine or the like is required. However, even if the assembly method is improved, there are, for example, circumstances where a structure in which a gap forms between the assembled outer conductors is undesirable in terms of shielding performance.

In view of this, an object of the present disclosure is to provide a shield terminal capable of improving shielding performance and parts assembly.

The shield terminal of the present disclosure is a shield terminal including a first outer conductor, a second outer conductor connected to the first outer conductor, and a module housed in the first outer conductor, in which the first outer conductor has one wall facing one side intersecting a front-rear direction, and an opening portion open to the one side at a position rearward of the one wall, the second outer conductor has a cover wall covering the opening portion, the module has an inner conductor to be connected to a front end portion of a shielded electric wire, and a dielectric housing the inner conductor, and is disposed facing the opening portion, and the cover wall has a second edge portion covering, from the one side, a first edge portion of the one wall facing the opening portion.

According to the present disclosure, it is possible to provide a shield terminal capable of improving shielding performance and parts assembly.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a shield terminal of a first embodiment of the present disclosure.

FIG. 2 is a cross-sectional view of a shield connector including the shield terminal of the first embodiment.

FIG. 3 is a perspective view of a first outer conductor in the shield terminal of the first embodiment.

FIG. 4 is a perspective view of a second outer conductor in the shield terminal of the first embodiment.

FIG. 5 is a perspective view of a module connected to a terminal portion of a shielded electric wire in the shield terminal of the first embodiment.

FIG. 6 is a perspective view showing a state in which the module is being inserted into a housing space of the first outer conductor in the shield terminal of the first embodiment.

FIG. 7 is a perspective view showing a state in which the module is inserted and housed in the housing space of the first outer conductor in the shield terminal of the first embodiment.

FIG. 8 is a perspective view showing a state immediately before the second outer conductor is assembled to the first outer conductor in the shield terminal of the first embodiment.

FIG. 9 is an enlarged cross-sectional view showing a state in which a second edge portion of the second outer conductor covers a first edge portion of the first outer conductor from above in the shield terminal of the first embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF THE DISCLOSURE

First, embodiments of the present disclosure will be listed and described.
(1) A shield terminal of the present disclosure including a first outer conductor, a second outer conductor connected to the first outer conductor, and a module housed in the first outer conductor, in which the first outer conductor has one wall facing one side intersecting a front-rear direction, and an opening portion open to the one side at a position rearward of the one wall, the second outer conductor has a cover wall covering the opening portion, the module has an inner conductor to be connected to a front end portion of a shielded electric wire, and a dielectric housing the inner conductor, and is disposed facing the opening portion, and the cover wall has a second edge portion covering, from the one side, a first edge portion of the one wall facing the opening portion.

The second outer conductor can be easily assembled to the first outer conductor from one side. When the second outer conductor is assembled to the first outer conductor, the second edge portion of the cover wall covers the first edge portion of the one wall, thus enabling a gap that can form between the cover wall and the one wall to be closed. As a result, it is possible to obtain a shield terminal that ensures shielding performance while improving assembly.
(2) In the shield terminal according to (1) above, it is preferable that the second outer conductor has a barrel portion to be connected by crimping to a shield portion of the shielded electric wire, and the first outer conductor has an insertion opening, through which the module is insertable, open at a position rearward of a housing space housing the module.

The module can be housed in the housing space by being inserted into the housing space from the rear of the first outer conductor through the insertion opening. Thus, the module can be easily assembled to the first outer conductor. In particular, since the second outer conductor has the barrel portion, the barrel portion can be omitted from the first outer conductor, and the insertion opening can be formed at the rear of the housing space without hindrance.
(3) In the shield terminal according to (2) above, it is preferable that the first outer conductor has a pair of first side walls disposed one first side wall on each of left and right sides of the housing space and facing in a direction intersecting the one wall, the first side walls each have an elastically deformable locking portion inclined inward of the first outer conductor from forward of a supporting point portion, and a cutout portion open around each locking portion, the module has a lock portion locked to each locking portion while the module is housed in the first outer conductor, the second outer conductor has a pair of second side walls protruding one second side wall from each of left and right end portions of the cover wall, and the second side walls are disposed to respectively cover the first side walls from outside the first outer conductor.

The module can elastically deform the locking portions during the process of being inserted into the housing space of the first outer conductor. When the module is inserted into the housing space, the locking portions elastically return to lock the lock portions and restrict the module from coming out of the housing space. Since the cutout portions open around the locking portions are closed by the second side walls covering the first side walls, shielding performance can be ensured.
(4) In the shield terminal according to any one of (1) to (3) above, it is preferable that the first edge portion has a shape bending inward of the first outer conductor from rearward of a joint portion of the first edge portion, and the second edge portion is disposed facing the first edge portion from behind.

The second edge portion is disposed facing the first edge portion that bends inward of the first outer conductor from behind, and the second edge portion is not disposed to be stacked on an outside of the one wall of the first outer conductor. Thus, a difference in level being formed due to the second edge portion can be prevented. For example, interference of the second edge portion with a lance of the housing can be avoided, when the shield terminal is inserted into the housing.

### DETAILED DESCRIPTION OF EMBODIMENTS OF THE DISCLOSURE

Specific examples of the present disclosure will be described below with reference to the drawings. Note that the present invention is not limited to these illustrative examples and is indicated by the claims, and all changes that come within the meaning and range of equivalency of the claims are intended to be embraced therein.

### First Embodiment

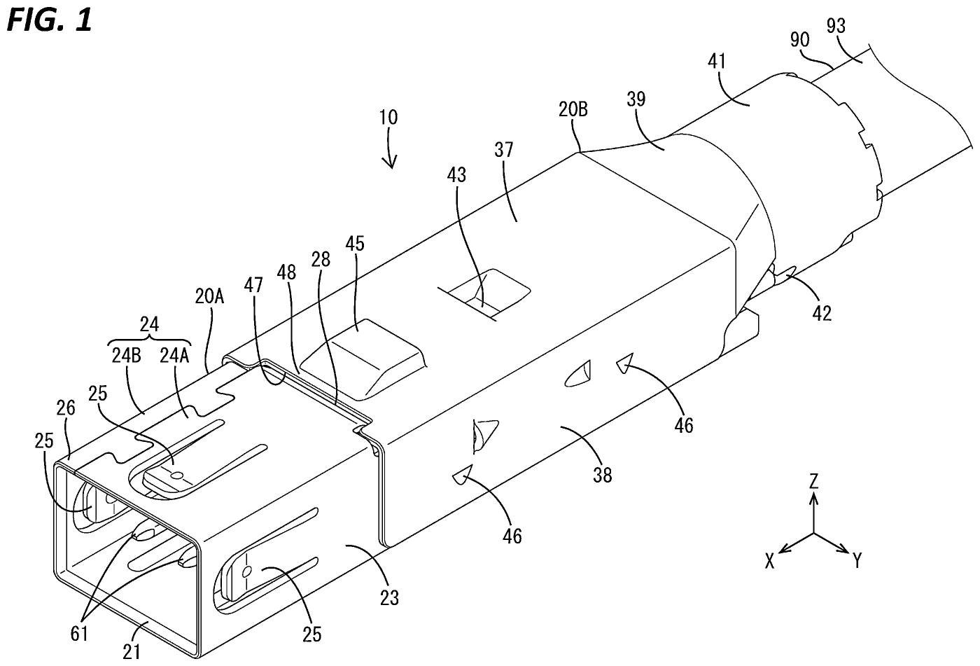

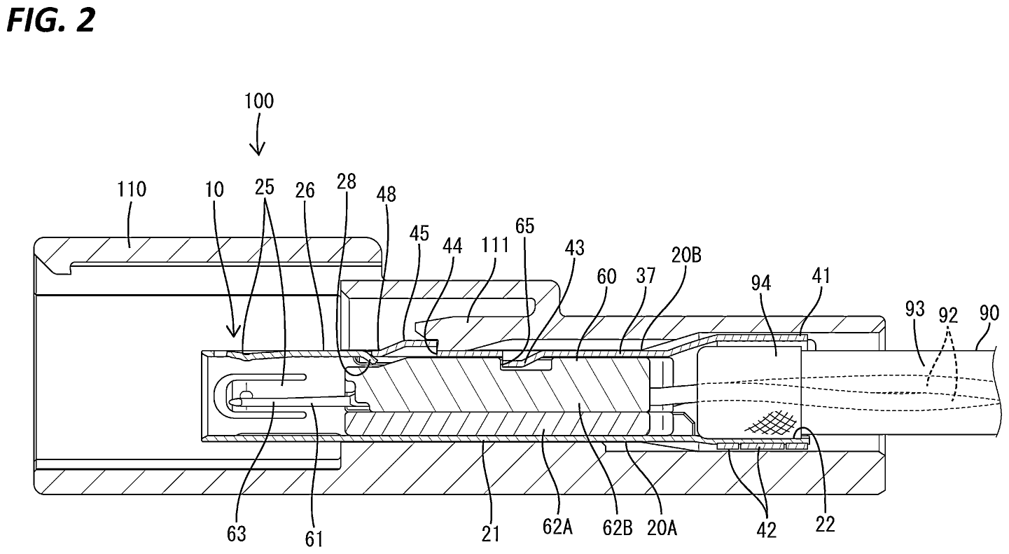

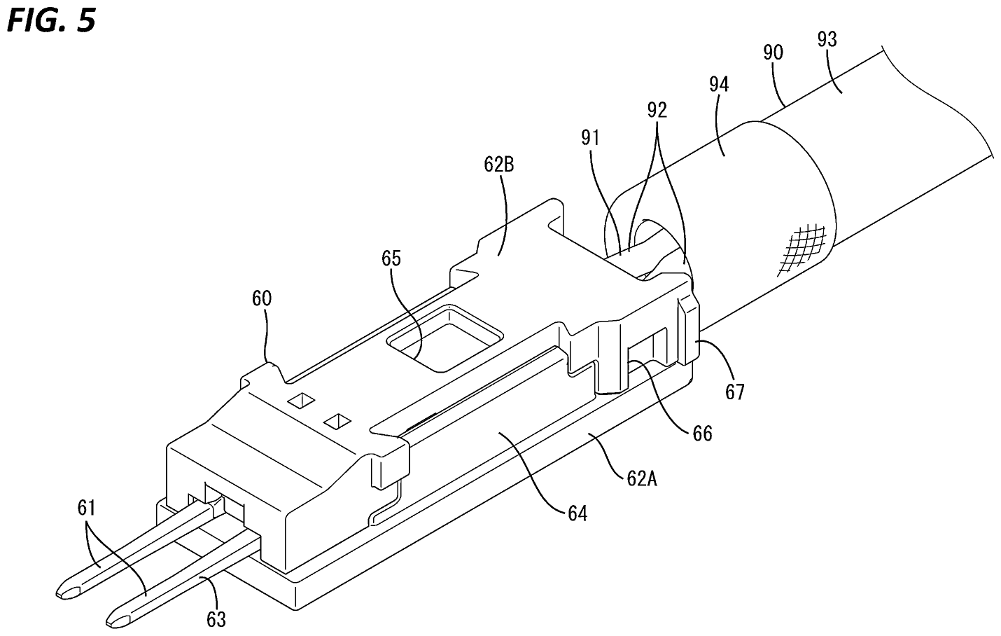

As shown in FIG. 1, a shield terminal 10 of a first embodiment is a terminal that is connected to a shielded electric wire 90. As shown in FIG. 2, the shield terminal 10 includes a module 60, a first outer conductor 20A, and a second outer conductor 20B. The shield terminal 10 is housed in a housing 110. A shield connector 100 is configured by the shield terminal 10 and the housing 110. As shown in FIG. 5, the module 60 includes an inner conductor 61 and dielectrics 62A and 62B. Note that, in the following description, a terminal side of the shielded electric wire 90 is a front side in the front-rear direction. An up-down direction is based on an up-down direction of each diagram. A left-right direction is based on a left-right direction when viewed from the front side. In FIG. 1, arrows X, Y, and Z respectively represent the front side, right side, and up side.

### (Inner Conductor and Shielded Electric Wire)

The inner conductor 61 is made of a conductive metal and, although not shown in detail, has an elongated shape in the front-rear direction as a whole. As shown in FIG. 5, the inner conductor 61 is illustrated as a male terminal having a tab 63 protruding forward. The inner conductor 61 is connected to a core wire (not shown) of the shielded electric wire 90.

The shielded electric wire 90 is constituted to include two covered electric wires 92 each having an outer periphery of the core wire covered by an insulating coating 91, a sheath 93 covering the covered electric wires 92, and a shield portion 94 such as a braided wire located on an inner peripheral side of the sheath 93 and surrounding an outer periphery of the covered electric wires 92. The shield portion 94 may be made of a metal foil such as a copper foil or an aluminum foil or may be made of both a braided wire and a metal foil. A front end portion of the shield portion 94 is exposed by stripping the sheath 93 and is folded back toward an outer peripheral side of the sheath 93. In the case of the first embodiment, the two covered electric wires 92 are a twisted pair wire and are untwisted at a position exposed from a front end of the sheath 93. At a front end portion of each covered electric wire 92, the core wire is exposed by stripping the insulating coating 91. Although not shown, the inner conductor 61 is connected to the core wire exposed at the front end portion of the covered electric wire 92. Two inner conductors 61 are provided in correspondence with the covered electric wires 92.

### (Dielectrics)

The dielectrics 62A and 62B are made of an insulating resin and, as shown in FIG. 5, are constituted to include a first dielectric 62A and a second dielectric 62B. The second dielectric 62B is disposed above the first dielectric 62A and, together with the first dielectric 62A, surrounds main body portions (portions excluding the tabs 63) of the inner conductors 61. The inner conductors 61 are housed side by side inside the second dielectric 62B. The first dielectric 62A has side portions 64 protruding upward and locking the second dielectric 62B.

The tab 63 of each inner conductor 61 is disposed to protrude forward of the dielectrics 62A and 62B. The covered electric wires 92 of the shielded electric wire 90 extend rearward of the dielectrics 62A and 62B. An upper surface lock portion 65 is recessed in an upper surface of the second dielectric 62B. The upper surface lock portion 65 has a rectangular opening shape in plan view, and, as shown in FIG. 2, can be locked by fitting an upper surface locking portion 43, which will be described later, of the second outer conductor 20B inside the upper surface lock portion 65. As shown in FIG. 5, lock portions 66 are recessed on left and right side surfaces of the second dielectric 62B. The lock portions 66 have a rectangular opening shape in side view, and can be locked by fitting locking portions 34, which will be described later, of the first outer conductor 20A inside the lock portions 66.

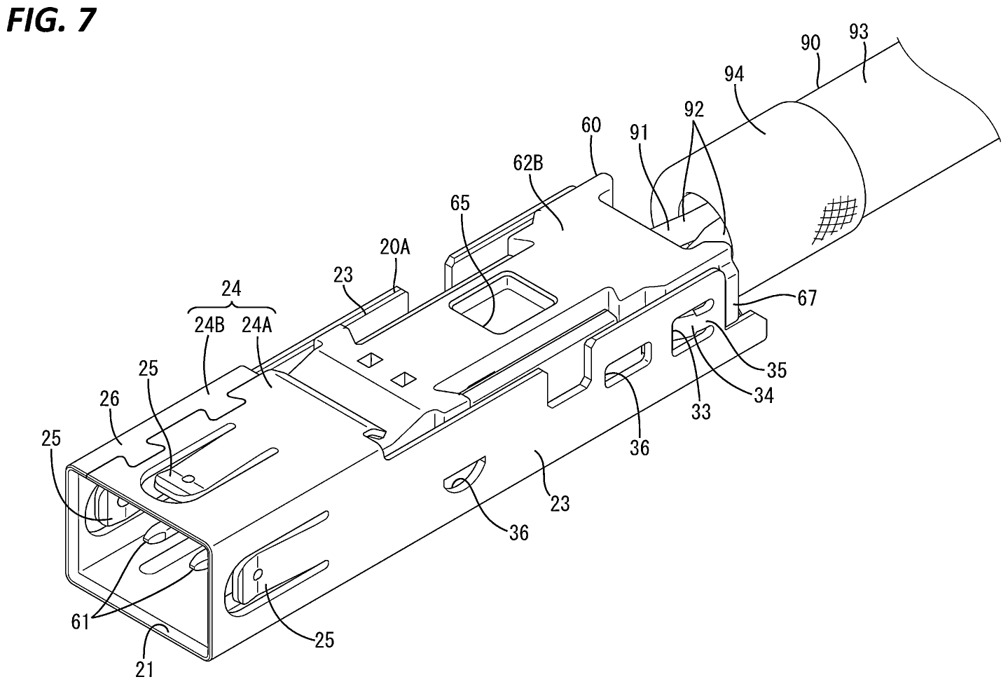

Further, rib-shaped stoppers 67 extending in the up-down direction are provided to protrude on the left and right side surfaces of the second dielectric 62B. The stoppers 67 are disposed side by side with the lock portions 66 at a rear end portion of the side surfaces of the second dielectric 62B. As will be described later, the stoppers 67 act to stop insertion of the module 60 into the first outer conductor 20A by abutting against a rear end of the first outer conductor 20A (see FIG. 7).

### (First Outer Conductor)

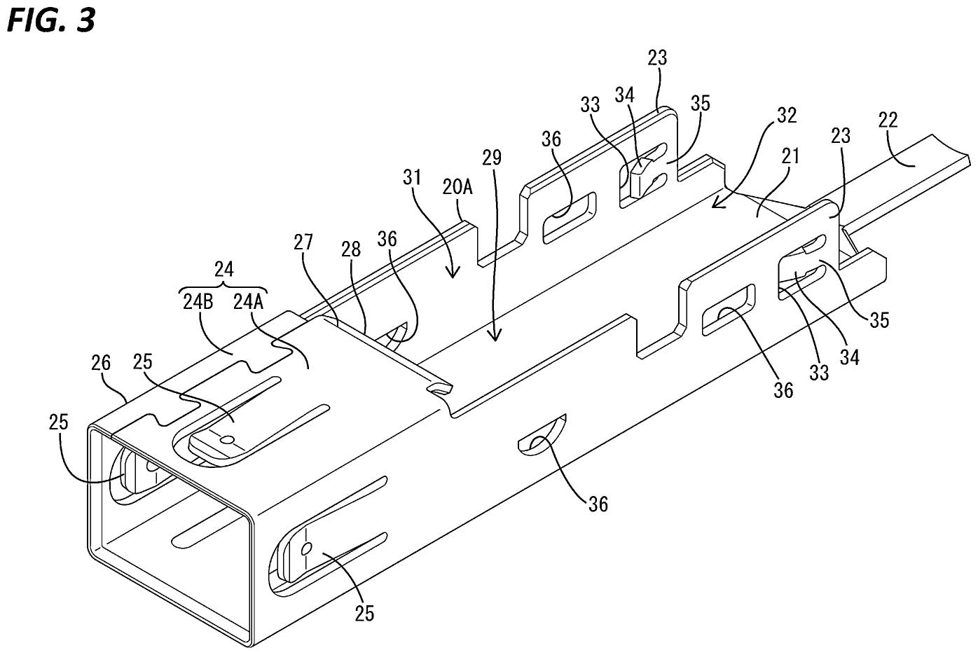

The first outer conductor 20A is made of a conductive metal and is formed by bending a metal plate through press working. As shown in FIG. 3, the first outer conductor 20A includes a base wall 21 extending in the front-rear direction and disposed with a plate surface thereof facing in the up-down direction, an extension portion 22 extending rearward from a laterally central portion of a rear end of the base wall 21, a pair of first side walls 23 extending one first side wall 23 upward from each of left and right end portions of the base wall 21, and one wall 24 spanning between upper ends of front portions of the first side walls 23.

The extension portion 22 has a band plate-like shape and can be locked to a barrel portion 41, which will be described later, of the second outer conductor 20B (see FIG. 2). Each first side wall 23 is formed over an entire length of the first outer conductor 20A in the front-rear direction with a plate surface thereof facing in the left-right direction. The one wall 24 includes one side portion 24A extending from one upper end toward the other upper end of the first side walls 23, and another side portion 24B extending from the other upper end toward the one upper end. The one side portion 24A is formed longer than the other side portion 24B in the left-right direction.

The one side portion 24A and the other side portion 24B are coupled together by engaging each other in an uneven manner at a position closer to one side from a lateral center of the one wall 24. Front portions of the base wall 21 and the first side walls 23, together with the one wall 24, constitute a tubular portion 26 having a square tube shape at a front portion of the first outer conductor 20A. An elastic contact portion 25 is formed by being cut and raised inward on each of the one side portion 24A and the first side walls 23. Each elastic contact portion 25 is electrically connected to a mating outer conductor (not shown) inserted inside the tubular portion 26.

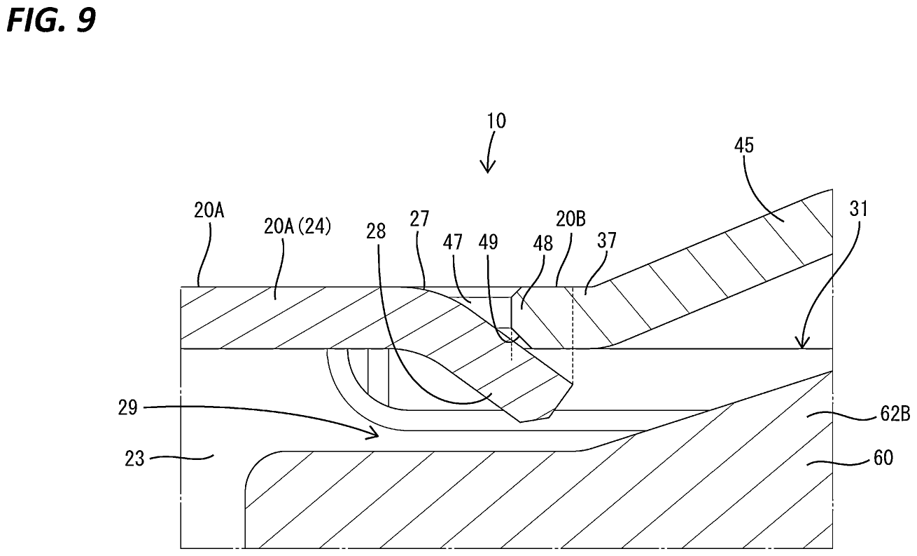

As shown in FIGS. 3 and 9, the one wall 24 has a first edge portion 28 that bends obliquely downward from rearward of a joint portion 27 that is continuous with a rear end of the one side portion 24A. The first edge portion 28 has a protruding piece shape and protrudes toward a housing space 29 which will be described later. As shown in FIG. 3, the first edge portion 28 is disposed to extend long in the left-right direction in a portion of the one wall 24 excluding both left and right end portions. The first edge portion 28 is not formed on the other side portion 24B side. As shown in FIG. 9, the joint portion 27 of the first edge portion 28 is bent downward in a curved shape. A second edge portion 48, which will be described later, of the second outer conductor 20B is disposed to cover the first edge portion 28 from above and behind.

The first outer conductor 20A forms a housing space 29 capable of housing the module 60, at a position rearward of the tubular portion 26. The housing space 29 communicates with the inside of the tubular portion 26 and is defined by the base wall 21 and the first side walls 23. A rear portion of the first outer conductor 20A has an opening portion 31 above the housing space 29. The opening portion 31 is longer than a front-rear length of the one wall 24 and is open in the front-rear direction. As shown in FIG. 9, when the module 60 is housed in the housing space 29, the upper surface of the second dielectric 62B faces the opening portion 31. As shown in FIG. 2, the tabs 63 of the inner conductors 61 are disposed to protrude inside the tubular portion 26.

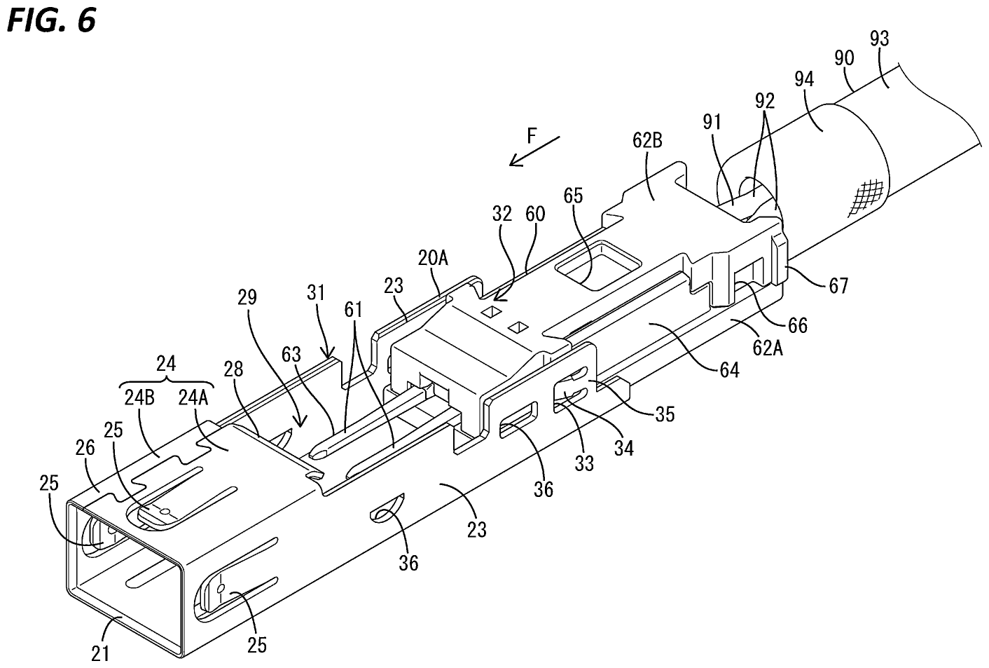

Further, as shown in FIGS. 3 and 6, the rear portion of the first outer conductor 20A has an insertion opening portion 32 through which the module 60 can be inserted from the rear, at a position rearward of the housing space 29. The insertion opening 32 communicates with the opening portion 31 and the housing space 29. The rear of the insertion opening 32 is open as an insertion path for the module 60.

A cutout portion 33 is open at a rear end portion of each first side wall 23. Also, a locking portion 34 is formed at the rear end portion of each first side wall 23 by bending a plate piece portion disposed inside the cutout portion 33 inward (toward the housing space 29). The locking portions 34 have a shape extending from supporting point portions 35 located at a rear end of the cutout portions 33 while inclining inward proceeding forward. The locking portions 34 can thereby be elastically deformed in the left-right direction using the supporting point portions 35 as supporting points. Due to the module 60 entering the insertion opening 32 and the locking portions 34 being elastically fitted into the lock portions 66 of the module 60, a front end of the locking portions 34 face a front end surface of the lock portions 66 (rearward-facing surface located at a front end of the lock portions 66) in a contactable state therewith. The module 60 is thereby restricted from coming out of the housing space 29.

Hold portions 36 are open between the elastic contact portion 25 and the locking portion 34 in each first side wall 23. The hold portions 36 pass through in the left-right direction and are arranged at intervals in the front-rear direction in each first side wall 23. Holding portions 46, which will be described later, of the second outer conductor 20B can be respectively locked to the hold portions 36.

### (Second Outer Conductor)

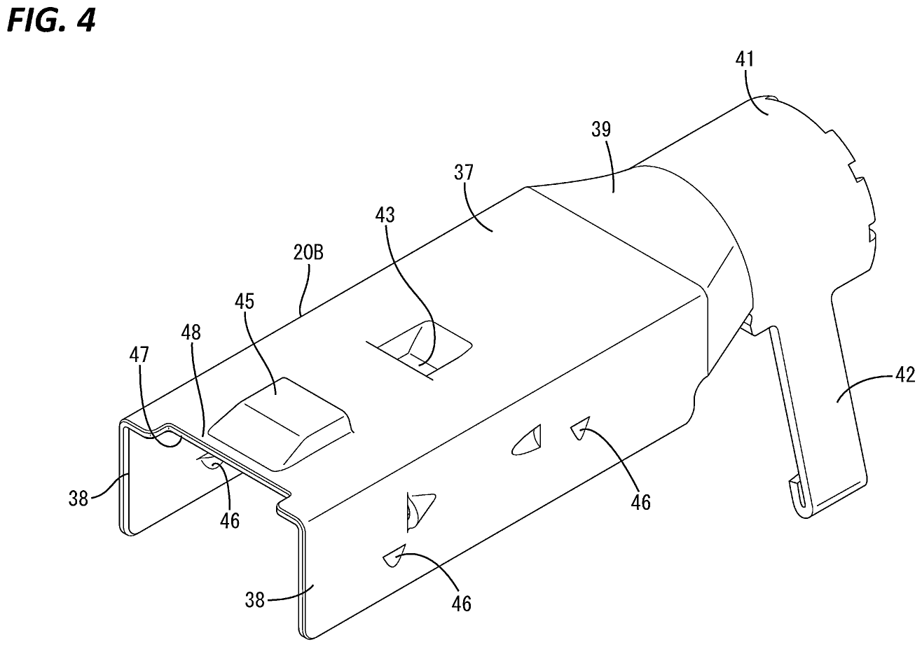

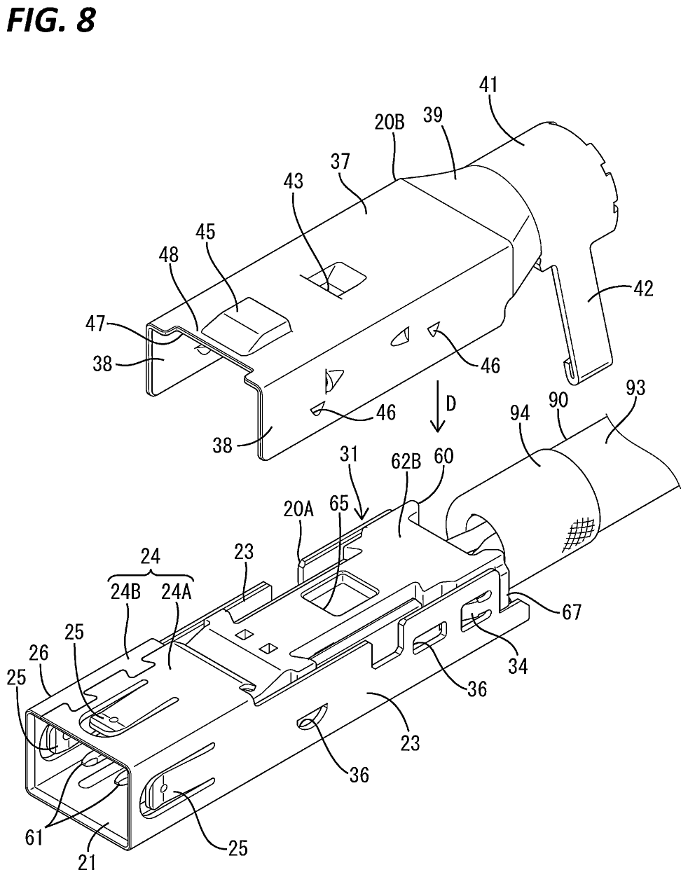

The second outer conductor 20B is made of a conductive metal and is formed by bending a metal plate through press working. The second outer conductor 20B is mounted to the first outer conductor 20A from above (see arrow D in FIG. 8). As shown in FIG. 4, the second outer conductor 20B includes a cover wall 37 extending in the front-rear direction and disposed with a plate surface thereof facing in the up-down direction, a pair of second side walls 38 protruding one second side wall 38 downward from each of left and right end portions of the cover wall 37, a coupling portion 39 extending rearward from rear ends of the cover wall 37 and the second side walls 38, and a barrel portion 41 protruding rearward from the coupling portion 39.

As shown in FIG. 2, the barrel portion 41 is crimped to a front end portion of the shielded electric wire 90 and connected to the shield portion 94 folded back toward the outer peripheral side of the sheath 93. As shown in FIG. 4, the barrel portion 41 has a pair of crimping pieces 42 (only one is shown in FIG. 4) facing each other in the left-right direction. The crimping pieces 42 receive the shield portion 94 of the shielded electric wire 90 in an open state shown in FIG. 4 and wrap around an outer peripheral surface of the shield portion 94 after being crimped. As shown in FIG. 2, the extension portion 22 is sandwiched between distal end portions of the crimping pieces 42 and the shield portion 94.

As shown in FIG. 9, the cover wall 37 covers the opening portion 31 and closes an upper portion of the housing space 29 while the second outer conductor 20B is mounted to the first outer conductor 20A.

As shown in FIGS. 2 and 4, in a central portion of the cover wall 37, an upper surface locking portion 43 that can lock to the upper surface lock portion 65 of the module 60 is formed by being cut and raised downward (toward a side where the first outer conductor 20A is located). Further, as shown in FIG. 2, at a front end portion of the cover wall 37, a cutout 44 extending in the left-right direction is formed at a position forward of the upper surface locking portion 43, and a housing locking portion 45 is formed by upwardly bending a portion forward of the cutout 44. The housing locking portion 45 is locked to a lance 111 that is locked to the housing 110. The shield terminal 10 is locked to the lance 111 and held in the housing 110 in a retained state.

As shown in FIG. 1, the second side walls 38 are arranged to cover the first side walls 23 from the outside of the first outer conductor 20A. Holding portions 46 that can be respectively locked to the hold portions 36 are formed on each second side wall 38. The holding portions 46 protrude continuously inward (inward in directions in which the second side walls 38 face each other). Similarly to the hold portions 36, the holding portions 46 are arranged at intervals in the front-rear direction.

A recess 47 is formed at the front end portion of the cover wall 37. The recess 47 is formed long in the left-right direction in a portion of the front end portion of the cover wall 37 excluding both left and right end portions. Also, a second edge portion 48 including an inner end portion of the recess 47 is formed at the front end portion of the cover wall 37. The second edge portion 48 extends in the left-right direction at the front end portion of the cover wall 37, and is continuously formed from an adjacent portion of the cover wall 37 without a difference in level. The second edge portion 48 is formed above the first edge portion 28 in a range overlapping with the first edge portion 28, as shown by dotted lines in FIG. 9. The housing locking portion 45 is disposed rearward of the second edge portion 48 in close proximity to the second edge portion 48.

As shown in FIG. 9, a sloping portion 49 is formed by chamfering at a lower corner portion of the second edge portion 48. The first edge portion 28 is fitted into the recess 47 of the cover wall 37 from the front. When the first edge portion 28 is fitted into the recess 47, the second edge portion 48 is disposed to cover the first edge portion 28 from above and face the first edge portion 28 from behind. Also, the second edge portion 48 is disposed rearward of the one side portion 24A of the one wall 24 while covering the first edge portion 28. The second edge portion 48 has a thickness that is the same as or similar to a thickness of the one side portion 24A and is disposed in a rearwardly protruding range of the one side portion 24A. The sloping portion 49 of the second edge portion 48 is disposed close to or in contact with the first edge portion 28 while facing the first edge portion 28 obliquely from behind.

### (Operation of Shield Terminal)

Next, an example of a procedure for assembling the shield terminal 10 will be described. First, a procedure for assembling the module 60 will be described.

The two inner conductors 61 are inserted and housed in the second dielectric 62B. Each inner conductor 61 is connected to the core wire of each covered electric wire 92 in advance. Subsequently, the second dielectric 62B is covered by the first dielectric 62A, and the inner conductors 61 are sandwiched between the first dielectric 62A and the second dielectric 62B. The module 60 is thereby completed.

Next, assume that the second dielectric 62B is disposed on the upper side with respect to the first dielectric 62A (see FIG. 5). In this state, as shown in FIG. 6, the module 60 is inserted into the housing space 29 through the insertion opening 32 from the rear of the first outer conductor 20A. The module 60 is moved straight forward along upper surfaces of the extension portion 22 and the base wall 21 (see arrow F in FIG. 6). During the process of moving the module 60, the second dielectric 62B interferes with the locking portions 34 and elastically deforms the locking portions 34 outward. When the module 60 reaches the position of being housed in the housing space 29 (position shown in FIG. 7), the locking portions 34 are elastically restored and respectively fitted into the lock portions 66, and the module 60 is restricted from coming out rearward and upward relative to the first outer conductor 20A.

Further, as shown in FIG. 7, when the module 60 reaches the position of being housed in the housing space 29, the stoppers 67 abut against the rear end of the first outer conductor 20A, and the module 60 is restricted from moving forward with respect to the first outer conductor 20A. The tabs 63 of the inner conductors 61 are disposed to protrude inside the tubular portion 26.

Subsequently, as shown in FIG. 8, the second outer conductor 20B is disposed above the first outer conductor 20A, and, in this state, the second outer conductor 20B is pulled straight down along arrow D. Also, the cover wall 37 covers the opening portion 31, and the second edge portion 48 covers the first edge portion 28 from above and behind. Further, the barrel portion 41 covers the shield portion 94 of the shielded electric wire 90 from above. By covering the first edge portion 28 with the second edge portion 48, a gap that can form between the one wall 24 of the first outer conductor 20A and the cover wall 37 of the second outer conductor 20B is closed, and the shielding performance required for the shield terminal 10 can be ensured. The second outer conductor 20B is held in a state of being restricted from coming out from the first outer conductor 20A, by locking the holding portions 46 to the hold portions 36 of the first outer conductor 20A. Thereafter, the barrel portion 41 is crimped onto the shield portion 94 of the shielded electric wire 90. This completes assembly of the shield terminal 10. Note that assembly of the module 60 to the first outer conductor 20A and assembly of the second outer conductor 20B to the first outer conductor 20A can be easily performed by an automatic machine (not shown).

As described above, according to the first embodiment, the second outer conductor 20B is assembled to the first outer conductor 20A from above so that the second edge portion 48 of the cover wall 37 covers the first edge portion 28 of the one wall 24. Also, by covering the first edge portion 28 with the second edge portion 48, a gap that can form between the cover wall 37 and the one wall 24 can be closed. Therefore, the shield terminal 10 of the first embodiment can ensure shielding performance while improving parts assembly.

Further, the barrel portion 41 is formed in the second outer conductor 20B, and the insertion opening 32 through which the module 60 can be inserted is open at a position rearward of the housing space 29 of the first outer conductor 20A. Since the module 60 is inserted into the housing space 29 through the insertion opening 32 from the rear of the first outer conductor 20A, the module 60 can be easily assembled to the first outer conductor 20A.

Further, in the case of the first embodiment, the first side walls 23 of the first outer conductor 20A include the locking portions 34 inclined inward from forward of the supporting point portions 35 and the cutout portions 33 open around the locking portions 34. Also, the module 60 has the lock portions 66 that are locked to the locking portions 34 while the module 60 is housed in the first outer conductor 20A, and the second side walls 38 of the second outer conductor 20B are disposed to cover the first side walls 23 from outside the first outer conductor 20A. Thus, when the module 60 is inserted into the housing space 29, the locking portions 34 can elastically return smoothly to lock the lock portions 66 and restrict the module 60 from coming out of the housing space 29. Further, since the cutout portions 33 open around the locking portions 34 are respectively covered by the second side walls 38 facing the first side walls 23, shielding performance can be ensured.

Furthermore, in the case of the first embodiment, the first edge portion 28 has a shape bending inward of the first outer conductor 20A from rearward of the joint portion 27, and the second edge portion 48 is disposed facing the first edge portion 28 from behind.

The second edge portion 48 is disposed facing the first edge portion 28 bent inward of the first outer conductor 20A from behind, and the second edge portion 48 is not disposed to be stacked on the outside of the one wall 24 of the first outer conductor 20A. Thus, a difference in level being formed due to the second edge portion 48 is prevented. Therefore, for example, interference of the second edge portion 48 with the lance 111 formed in the housing 110 can be avoided, when the shield terminal 10 is inserted into the housing 110. As a result, it is also possible to improve assembly of the shield terminal 10 to the housing 110.

### Other Embodiments of the Present Disclosure

The first embodiment disclosed above is to be considered illustrative in all respects and not restrictive.

In the case of the first embodiment, the first edge portion has a shape bending inward of the first outer conductor from rearward of the joint portion. In contrast, according to another embodiment, the first edge portion may have a shape extending straight from rearward of the joint portion. Alternatively, the first edge portion may be formed continuously in the left-right direction at the rear end portion of the one wall, rather than protruding from the rear end portion of the one wall.

In the case of the first embodiment, the barrel portion is formed only in the second outer conductor, and a barrel portion is not formed in the first outer conductor. In contrast, according to another embodiment, a barrel portion may also be formed in the first outer conductor.

In the case of the first embodiment, the dielectric is configured to be divisible into the first dielectric and the second dielectric. In contrast, according to another embodiment, the dielectric may be integrally configured without distinguishing between the first dielectric and the second dielectric.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shield terminal comprising a first outer conductor, a second outer conductor connected to the first outer conductor, and a module housed in the first outer conductor, wherein
the first outer conductor has one wall facing one side intersecting a front-rear direction, and an opening portion open to the one side at a position rearward of the one wall,
the second outer conductor has a cover wall covering the opening portion,
the module has an inner conductor to be connected to a front end portion of a shielded electric wire, and a dielectric housing the inner conductor, and is disposed facing the opening portion, and
the cover wall has a second edge portion covering, from the one side, a first edge portion of the one wall facing the opening portion.

2. The shield terminal according to claim 1, wherein
the second outer conductor has a barrel portion to be connected by crimping to a shield portion of the shielded electric wire, and
the first outer conductor has an insertion opening, through which the module is insertable, open at a position rearward of a housing space housing the module.

3. The shield terminal according to claim 2, wherein
the first outer conductor has a pair of first side walls disposed one first side wall on each of left and right sides of the housing space and facing in a direction intersecting the one wall,
the first side walls each have an elastically deformable locking portion inclined inward of the first outer conductor from forward of a supporting point portion, and a cutout portion open around each locking portion,
the module has a lock portion locked to each locking portion while the module is housed in the first outer conductor,
the second outer conductor has a pair of second side walls protruding one second side wall from each of left and right end portions of the cover wall, and
the second side walls are disposed to respectively cover the first side walls from outside the first outer conductor.

4. The shield terminal according to claim 1, wherein
the first edge portion has a shape bending inward of the first outer conductor from rearward of a joint portion of the first edge portion, and
the second edge portion is disposed facing the first edge portion from behind.
